(19) United States
(12) Patent Application Publication
(10) Pub. No.: US 2026/0154055 A1
(43) Pub. Date: Jun. 4, 2026

(54) REGIONALIZATION SYSTEM FOR A VEHICLE

(71) Applicant: GM Global Technology Operations LLC, Detroit, MI (US)

(72) Inventor: Brian Farrell, Troy, MI (US)

(73) Assignee: GM Global Technology Operations LLC, Detroit, MI (US)

(21) Appl. No.: 18/964,146

(22) Filed: Nov. 29, 2024

(51) Int. Cl. G06F 8/65; G06F 21/57; G06F 21/60

(52) U.S. Cl. CPC G06F 8/65; G06F 21/575; G06F 21/602

(57) ABSTRACT

A computer-implemented method when executed by data processing hardware causes the data processing hardware to perform operations. The operations include providing, at a system on chips (SoC) of a radar module, a common encryption key and a unique encryption key, providing, at the SoC, a unique key pair, the unique key pair including a unique public key and a unique private key, and encrypting software with the common encryption key. The operations also include generating a secure boot certificate for the encrypted software, signing, using the unique private key, the secure boot certificate, and writing, the encrypted software, to an external flash memory. The operations further include updating, at the SoC, software, verifying, via a regional public key, the software update, and signing, via a hardware security module (HSM) of the SoC, the secure boot certificate with a device-unique private key.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a method for regionalizing automotive controllers implementing secure boot and, more specifically, to a regionalization system for an automotive electronic control unit (ECU) of a vehicle.

Modern vehicles have seen rapid technological advancements in the number of electronics and associated software included within the vehicle. For example, electronic control units (ECUs) are used as embedded systems within the vehicle that control various electromechanical systems. However, there is a need to support multiple public key infrastructures (PKIs) in the automotive ECUs for the vehicles to be sold in domestic and foreign regions. Specifically, there is a need for improved cryptographic key protection for vehicles that are sold in foreign regions and manufactured in domestic regions.

### SUMMARY

In some aspects, a computer-implemented method when executed by data processing hardware causes the data processing hardware to perform operations. The operations include providing, at a system on chips (SoC) of a radar module, a common encryption key and a unique encryption key, providing, at the SoC, a unique key pair, the unique key pair including a unique public key and a unique private key, and encrypting software with the common encryption key. The operations also include generating a secure boot certificate for the encrypted software, signing, using the unique private key, the secure boot certificate, and writing, the encrypted software, to an external flash memory. The operations further include updating, at the SoC, software, verifying, via a regional public key, the software update, and signing, via a hardware security module (HSM) of the SoC, the secure boot certificate with a device-unique private key.

In some examples, providing the unique key pair may include hashing the unique public key at a fuse of the SoC, storing hash of the unique public key in the fuses, and encrypting the unique private key with the unique encryption key. Optionally, the external flash memory may include flash bootloader software including a default regional public key. The operations may also include verifying, via a diagnostic routine with default regional public keys, the regional public key and regional credentials of the flash bootloader software. The operations may further include verifying, via a flash bootloader of the SoC and the HSM of the SoC, a regionalization record using the default regional public keys. In some instances, the operations may include storing the default regional public key and regional credentials in the external flash memory in response to the verified regionalization record, executing, at the SoC, a diagnostic routine including verifying the regional public key of the external flash memory, and provisioning, to the SoC, the regional credentials corresponding to the default regional public key of the external flash memory. The operations may further include receiving, at a flash bootloader of the SoC, a software update and verifying, via the HSM, the software update using the regional public key from the external flash memory.

In other aspects, a regionalization system for a radar module of a vehicle includes data processing hardware and memory hardware in communication with the data processing hardware. The memory hardware stores instructions that when executed on the data processing hardware cause the data processing hardware to perform operations. The operations include providing, at a system of chips (SoC) of a radar module, a common encryption key and a unique encryption key, providing, at the SoC, a unique key pair, the unique key pair including a unique public key and a unique private key, encrypting software with the common encryption key, and generating a secure boot certificate for the encrypted software. The operations also include signing, using the unique private key, the secure boot certificate, writing, the encrypted software, to an external flash memory, executing, at the SoC, a diagnostic routine including verifying a regional root public key of the external flash memory, and provisioning, to the SoC, regional credentials and the regional root public key.

In some examples, providing the unique key pair may include hashing the unique public key at fuses of the SoC, storing hash of the unique public key in the fuses, and encrypting the unique private key with the unique encryption key prior to storing the unique private key in the external flash memory. Optionally, the external flash memory may include flash bootloader software including default regional public keys. The operations may also include verifying, via the diagnostic routine with default regional public keys, the regional public key and the regional credentials and default credentials of the flash bootloader software. The operations may further include verifying, via a flash bootloader of the SoC and a hardware security module (HSM) of the SoC, a regionalization record using the default regional public keys. In some instances, the operations may include storing the regional public key and the regional credentials in the external flash memory in response to the verified regionalization record, executing, at the SoC, a diagnostic routine including verifying the regional public key of the external flash memory, and provisioning, to the SoC, regional credentials corresponding to the regional public key of the external flash memory. The operations may also include receiving, at a flash bootloader of the SoC, a software update and verifying, via the HSM, the software update using the regional public key from the external flash memory.

In further aspects, a regionalization system for a vehicle includes data processing hardware and memory hardware in communication with the data processing hardware. The memory hardware stores instructions that when executed on the data processing hardware cause the data processing hardware to perform operations. The operations include providing, at a system of chips (SoC) of a radar module, a common encryption key and a unique encryption key, providing, at the SoC, a unique key pair, the unique key pair including a unique public key and a unique private key, encrypting software with the common encryption key, and generating a secure boot certificate for the encrypted software. The operations also include signing, using the unique private key, the secure boot certificate, writing, the encrypted software, to an external flash memory, and executing, at the SoC, a diagnostic routine including verifying a default regional public key of the external flash memory. The operations further include verifying, via a flash bootloader of the SoC and a hardware security module (HSM) of the SoC, a regionalization record using the default regional public key of the external flash memory and regional credentials, provisioning, to the SoC, regional credentials and the default regional public key, and storing the provisioned regional credentials in response to the verified regionalization record.

In some examples, providing the unique key pair may include hashing the unique public key at fuses of the SoC, storing hash of the unique public key in the fuses, and encrypting the unique private key with the unique encryption key. Optionally, the external flash memory may include flash bootloader software including the default regional public key. The operations may also include verifying, via the diagnostic routine with the regional public key, the regional public key and the regional credentials of the flash bootloader software. The operations may also include storing the provisioned regional credentials in response to the verified regionalization record. In some instances, the operations may include receiving, at a flash bootloader of the SoC, a software update and verifying, via the HSM, the software update using the default regional public key from the external flash memory.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a radar module according to the present disclosure;

FIG. 2 is an exemplary block diagram of a regionalization system according to the present disclosure for a radar module;

FIG. 3 is another exemplary block diagram of a regionalization system according to the present disclosure, the regionalization system including a system of chips (SoC) and an external flash memory;

FIG. 4 is a further exemplary block diagram of a regionalization system according to the present disclosure, the regionalization system configuring an SoC and an external flash memory;

FIGS. 5-9 illustrate an exemplary startup process for a regionalization system according to the present disclosure;

FIGS. 10 and 11 illustrate an exemplary software update for a regionalization system according to the present disclosure; and

FIG. 12 illustrates an exemplary method for executing a regionalization system according to the present disclosure.,

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

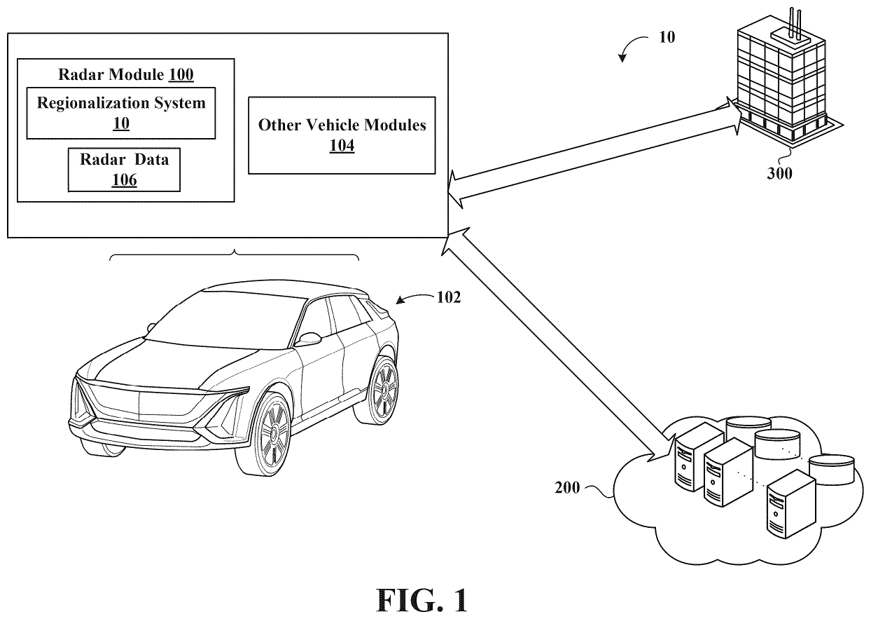

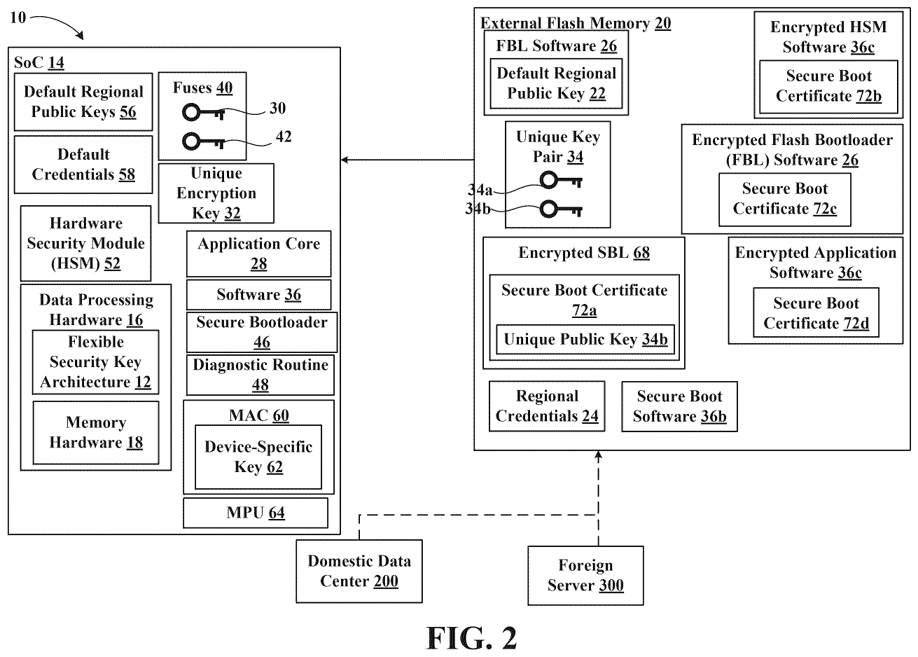

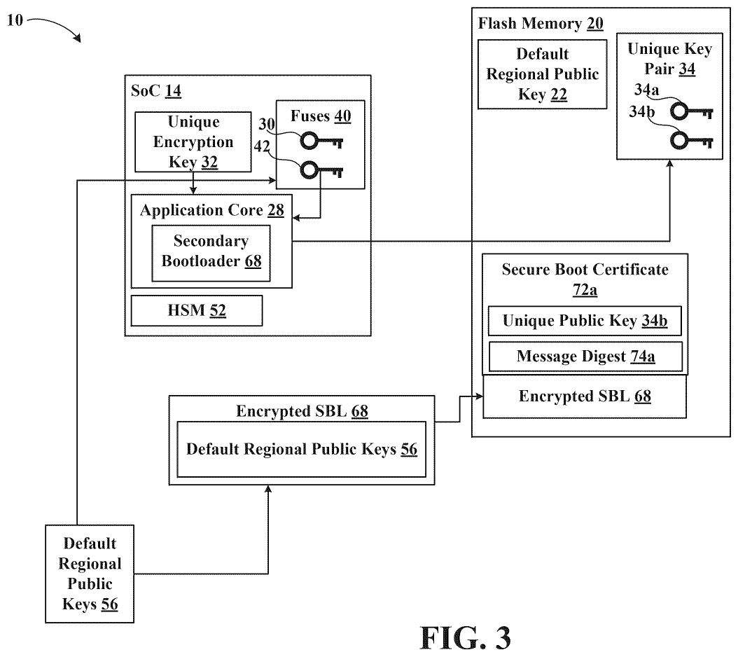

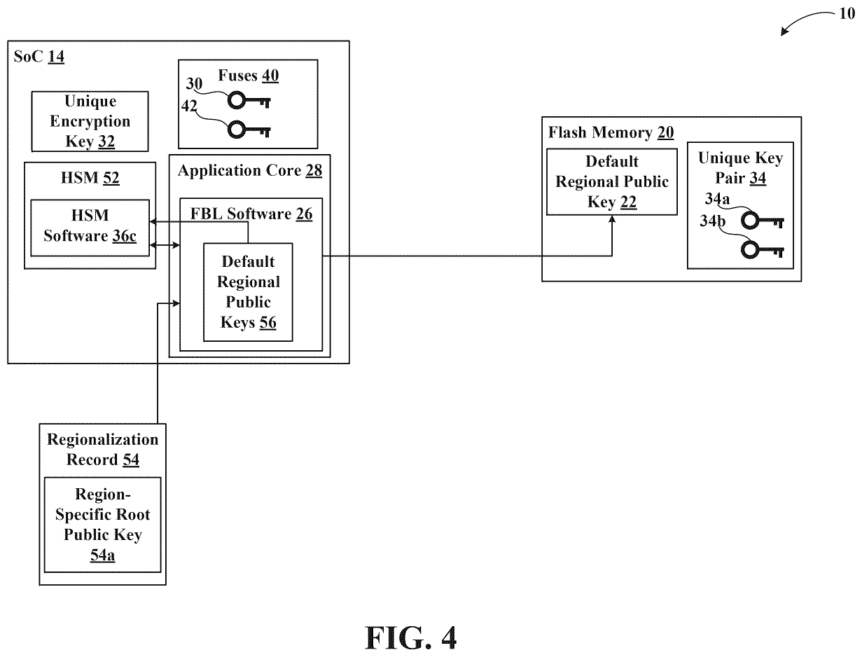

Referring to FIGS. 1-4, a regionalization system 10 is configured as part of a radar module 100 for a vehicle 102. The radar module 100 is manufactured and separately configured from the vehicle 102 and installed for use with various operations of the vehicle 102. Thus, the regionalization system 10 of the radar module 100 is configured to communicate with other vehicle modules 104 during operation of the vehicle 102. The radar module 100 is configured to detect objects near or surrounding the vehicle 102 during operation and provide radar data 106 to the other vehicle modules 104. Each radar module 100 is configured for communication with one of a domestic data center 200 and a foreign server 300. For example, the regionalization system 10 is configured with flexible security key architecture 12 that is configured to allow communication between one of the domestic data center 200 or the foreign server 300, as described in more detail below. For purposes of simplification, a single foreign server 300 is described. However, it is contemplated that multiple servers 300 may be utilized as part of the regionalization system 10.

The radar module 100 also includes a system on chips (SoC) 14 configured with data processing hardware 16 and memory hardware 18. The data processing hardware 16 configured to execute the flexible security key architecture 12 and operations associated with the regionalization system 10. The memory hardware 18 is configured as a temporary memory, such that data stored on the memory hardware 18 may be erased upon reset of the regionalization system 10. The memory hardware 18 is in communication with the data processing hardware 16 and stores instructions that, when executed by the data processing hardware 16, causes the data processing hardware 16 to perform operations, described herein.

The radar module 100 also includes an external flash memory 20 that is communicatively coupled with the SoC 14. The external flash memory 20 includes a default regional public key 22 stored in flash bootloader (FBL) software 26. Regional credentials 24 are provided to the external flash memory 20, as described in more detail below. The FBL software 26 contains the default regional public key 22, which are utilized by the SoC 14 to verify the regional credentials 24. The regional public key 22 and the regional credentials 24 inform with which of the domestic data center 200 and the foreign server 300 the radar module 100 is configured to communicate. The radar module 100 is thus configured to receive communications from only one of the domestic data centers 200 or the foreign server 300, which is verified by the regional key 22 and the regional credentials 24.

With further reference to FIGS. 1-4, the SoC 14 also includes an application core 28, described in more detail below, and is provided a common encryption key 30, a unique encryption key 32, and a device-unique key pair 34. The common encryption key 30 may be generated within the SoC 14 and/or may be provided to the SoC 14 from the external flash memory 20. The common encryption key 30 is utilized to encrypt software 36. For example, the software 36 may include, but is not limited to, application software 36a, secure bootloader software 36b, and hardware security module (HSM) software 36c. The software 36 may also include, in some examples, the FBL software 26. The regionalization system 10 may also periodically receive software updates 38, which are verified using the regional public key 22, as described in more detail below.

The common encryption key 30 and the unique encryption key 32 may be set in fuses 40 of the SoC 14. The unique key pair 34 is provided by the external flash memory 20 and includes a device-unique private key 34a and a device-unique public key 34b. The hash of the unique public key 34b is stored in the fuses 40 of the SoC 14. As a result, a public key hash 42 is stored in the fuse 40. The unique private key 34a is encrypted with the unique encryption key 32 and is stored in the external flash memory 20. The external flash memory 20 also includes secure boot certificates 72, described below, that are generated for the software 36. The secure boot certificates 72 are signed by the unique private key 34a and written to the external flash memory 20 for storage.

The SoC 14 also includes a secure bootloader 46 that is configured to execute a diagnostic routine 48 of the SoC 14. The diagnostic routine 48 is configured to ensure that the common encryption key 30, the unique encryption key 32, and the unique key pairs 34 were correctly provisioned to the SoC 14. For example, the diagnostic routine 48 may include verifying the regional credentials 24 of the flash bootloader (FBL) software 26 with the regional public key 22 of the external flash memory 20. The SoC 14 also receives the regional credentials 24 from the external flash memory 20, which corresponds to the regional public key 22 of the external flash memory 20. The regional credentials 24 are utilized by the SoC 14 during operation of the radar module 100 to support securely setting the radar module 100 to be used with one of the domestic data centers 200 or the foreign server 300.

Referring still to FIGS. 1-4, the SoC 14 also includes the flash bootloader (FBL) software 26 loaded into the application core 28 and a hardware security module (HSM) 52. The FBL software 26 and the HSM 52 are configured to verify a regionalization record 54 using default regional public keys 56 from the FBL SOFTWARE 26 and default credentials 58. The regionalization record 54 includes a region-specific root public key 54a, which is compared with the default regional public keys 56 to verify the authenticity of software updates, which are provided through the diagnostic routine 48.

The FBL SOFTWARE 26 coordinates with the HSM 52 to verify the regionalization record 54 using the default regional public keys 56 and the default credentials 58 provided during manufacturing of the regionalization system 10 of the radar module 100. If the regionalization record 54 is verified, then the SoC 14 stores the provisioned regional root public key 54a as the regional public key 22 in the external flash memory 20. The SoC 14 protects the regionalization record 54 from potential tampering by generating a message authentication code (MAC) 60 with a device-specific key 62. The MAC 60 are stored on the external flash memory 20 with the regional public key 22.

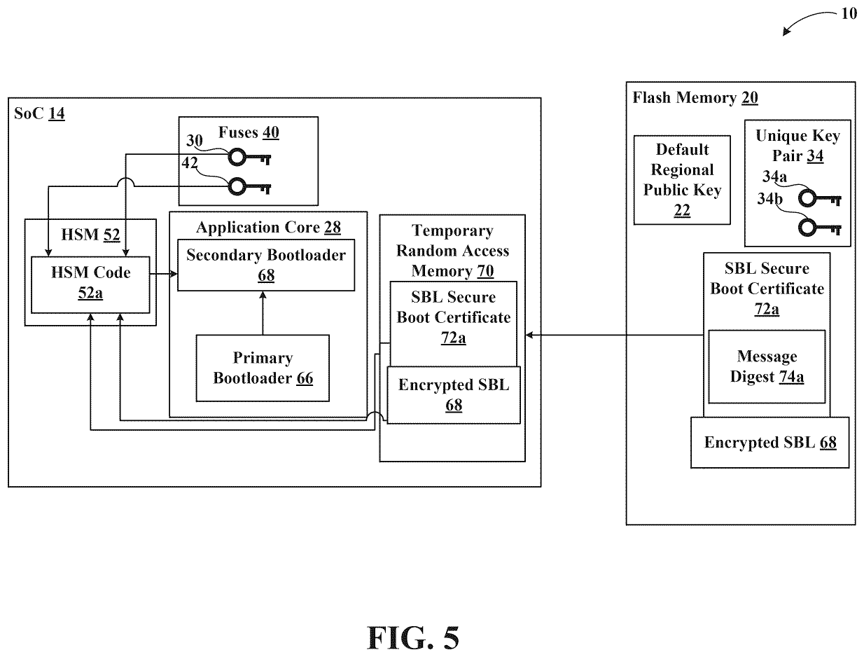

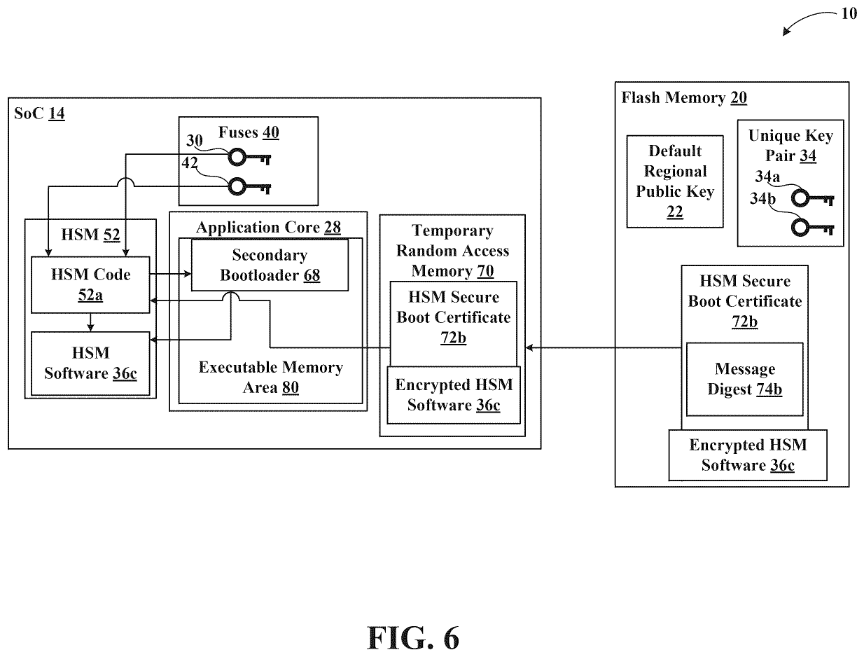

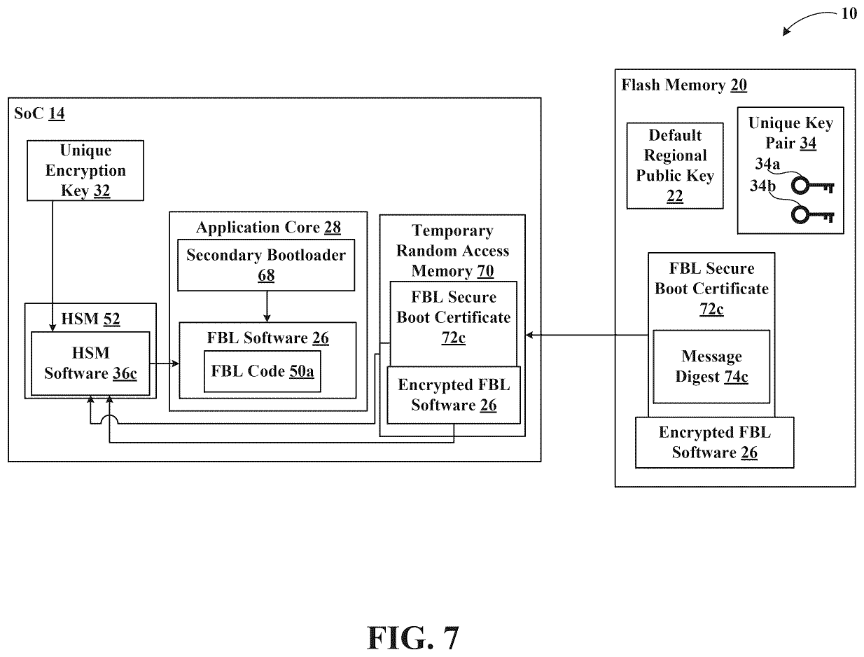

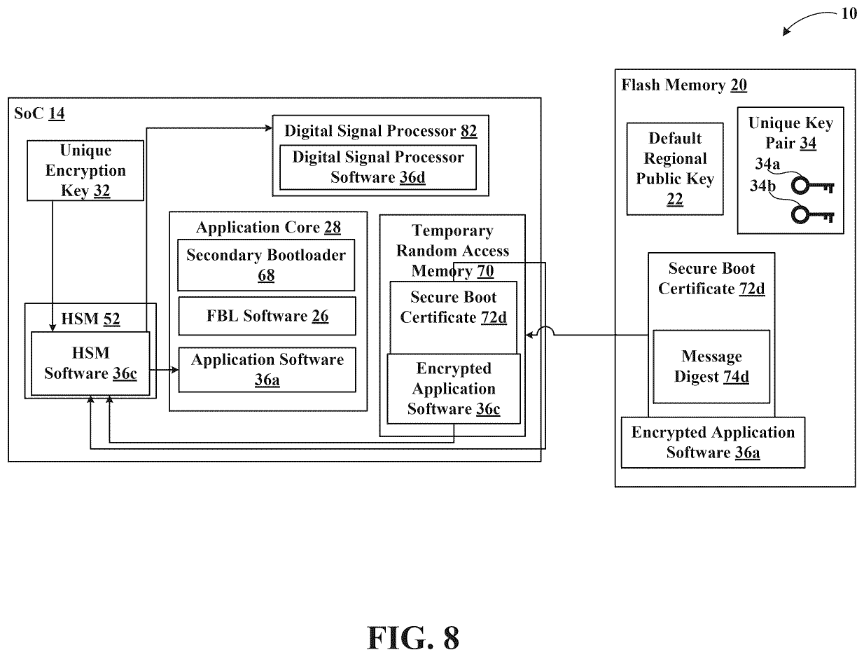

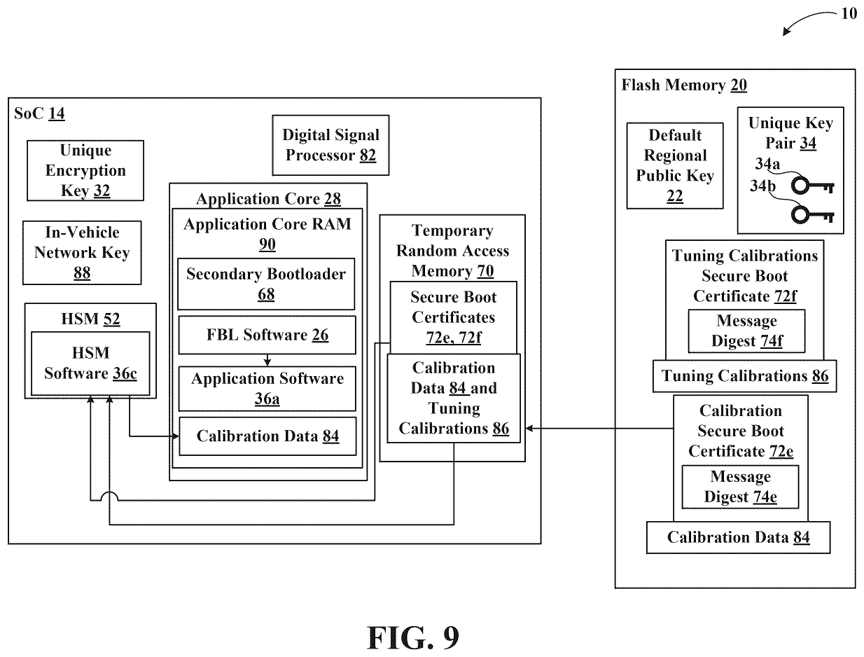

With reference now to FIGS. 5-9, the SoC 14 includes a memory protection unit (MPU) 64 configured as part of the application core 28. The MPU 64 is only configurable by the HSM 52 of the SoC 14. A primary bootloader (PBL) 66 of the application core 28 is configured to load an encrypted secondary bootloader (SBL) 68 from the external flash memory 20 into a temporary random access memory 70 of the SoC 14. The PBL 66 loads a secure boot certificate 72, 72a with the encrypted secondary bootloader 68. There may be one or more secure boot certificates 72 containing one or more message digests 74. For example, the PBL 66 requests an HSM code 52a of the HSM 52 to verify a secondary bootloader (SBL) secure boot certificate 72a of the encrypted secondary bootloader 68. In doing so, the HSM code 52a verifies that the hash of the unique public key 34b matches the public key hash 42 (i.e., a valid signature) and then uses the unique public key 34b to verify the signature of the secure boot certificate 72. The HSM code 52a also verifies an SBL message digest 74a of the encrypted secondary bootloader 68 that is within the signed secure boot certificate 72. The HSM 52 also configures the MPU 64 to prevent modification of the temporary random access memory 70 prior to calculating the message digest 74. If everything was verified successfully, the PBL 66 requests the HSM code 52a to decrypt the encrypted secondary bootloader 68 with the common encryption key 30. Once the encrypted secondary bootloader 68 is decrypted, the PBL 66 requests the HSM code 52a to load the secondary bootloader 68 into the application random access memory (RAM) 36a, and the PBL 66 jumps to the secondary bootloader 68.

Secondary bootloader (SBL) code 68a is run by the application core 28 and loads encrypted HSM software 36c from the external flash memory 20 into the temporary random access memory 70. The secondary bootloader 68 is configured to request the HSM ROM code 52a to verify an HSM secure boot certificate 72b of the encrypted HSM software 36c. In doing so, the HSM ROM code 52a verifies that the hash of the unique public key 34b matches the public key hash 42 (i.e., a valid signature) and then uses the unique public key 34b to verify the signature of the secure boot certificate 72b. The HSM ROM code 52a also verifies an HSM message digest 74b of the encrypted HSM software 36c that is within the signed secure boot certificate 72b. The HSM 52 also configures the MPU 64 to prevent modification of the temporary random access memory 70 prior to calculating the message digest 74b. If everything is verified successfully, the secondary bootloader 68 is also configured to request the HSM ROM code 52a to decrypt the encrypted HSM software 36c with the common encryption key 30. The HSM ROM code 52a may then load the decrypted HSM software 36c into the HSM 52. The HSM ROM code 52a is configured to jump to the HSM software 36c. The HSM ROM code 52a provides the verified unique public key 34b, which is used by the HSM 52 to verify the secure boot certificates 72. The secondary bootloader 68 provides the HSM software 36c with HSM data 52b from the external flash memory 20.

With further reference to FIGS. 5-9, the HSM software 36c is configured to configure the MPU 64 to limit writing capabilities to the HSM 52. For example, the HSM 52 is allowed to write to an executable memory area 80 of the application core 28. As a result, the application core 28 is unable to modify the executable memory area 80 of the application core 28 where all application core software (e.g., secondary bootloader 68 and the FBL software 26) will be loaded. The application core 28 is only able to execute from the executable memory area 80. The SBL code 68a is now configured to run in the application core 28 and is configured to load an encrypted FBL software 26 from the external flash memory 20 into the temporary random access memory 70. The secondary bootloader 68 requests the HSM software 36c to verify an FBL secure boot certificate 72c for the encrypted FBL software 26. As similarly described above, the HSM software 36c verifies that the hash of the unique public key 34b matches the public key hash 42 (i.e., a valid signature) and then uses the unique public key 34b to verify the signature of the secure boot certificate 72c. In addition, the HSM software 36c verifies an FBL message digest 74c of the encrypted FBL software 26 within the signed secure boot certificate 72c. The HSM 52 also configures the MPU 64 to prevent modification of the temporary random access memory 70 prior to calculating the message digest 74c. Both verifications by the HSM software 36c are configured to prevent modification of the temporary random access memory 70 until verification and decryption is complete. Restricting modification of the temporary random access memory 70 minimizes and prevents issues with time of check and time of use.

If everything was verified successfully, the secondary bootloader 68 may request the HSM software 36c to decrypt the encrypted FBL SOFTWARE 26 with the common encryption key 30. The FBL SOFTWARE 26 may then be loaded onto the application core 28. For example, the HSM 52 may use a load address from the FBL secure boot certificate 72c, and the secondary bootloader 68 may jump to the FBL software 26 after it is successfully verified and decrypted. FBL code 50a may run in the application core 28 to load encrypted application software 36a from the external flash memory 20 into the temporary random access memory 70. The FBL SOFTWARE 26 requests that the HSM software 36c verify a secure boot certificate 72d and a message digest 74d of the encrypted application software 36a. The HSM 52 may configure the MPU 64 to prevent modification of the temporary random access memory 70 until verification and decryption is complete. The FBL SOFTWARE 26 further requests the HSM 52 to verify and decrypt the encrypted application software 36a using the common encryption key 30. The application software 36a is then loaded into the application core 28. The FBL SOFTWARE 26 requests that the HSM 52 also verify and decrypt digital signal processor software 36d with the common encryption key 30, which is then loaded into a digital signal processor 82 of the SoC 14.

Referring still to FIGS. 5-9, the FBL code 50a executed on the application core 28 loads calibration data 84 and tuning calibrations 86 from the external flash memory 20 into the temporary random access memory 70. The FBL SOFTWARE 26 requests the HSM software 36c to verify a cal secure boot certificate 72e, a cal message digest 74e, a tuning cals secure boot certificate 72f and a tuning cals message digest 74f. As described above, the HSM 52 configures the MPU 64 to prevent modification of the temporary random access memory 70 until verification is completed. The FBL SOFTWARE 26 also requests the HSM software 36c to load the calibration data 84 and the tuning calibrations 86 into the application core 28.

Once the HSM software 36c verifies the requests, the HSM software 36c allows for use of an in-vehicle network (IVN) key 88, which allows the device to affect the behavior of other devices in the vehicle. The MPU 64 is configured to allow the application core 28 to write to an application core random access memory (RAM) 90. The MPU 64 also allows the application core 28 to execute the application software 36a. The application core 28 jumps from execution of the FBL software 26 to the application software 36a that was loaded to the application core RAM 90. The digital signal processor 82 is activated, and the MPU 64 is configured to prevent further writing on the digital signal processor 82. The processes described herein is applicable to all software 26, 36 and calibration data 84 that can be updated, such that these processes apply to all updates to the elements described herein (i.e., the SBL 46, software 26, 36, and calibration data 84).

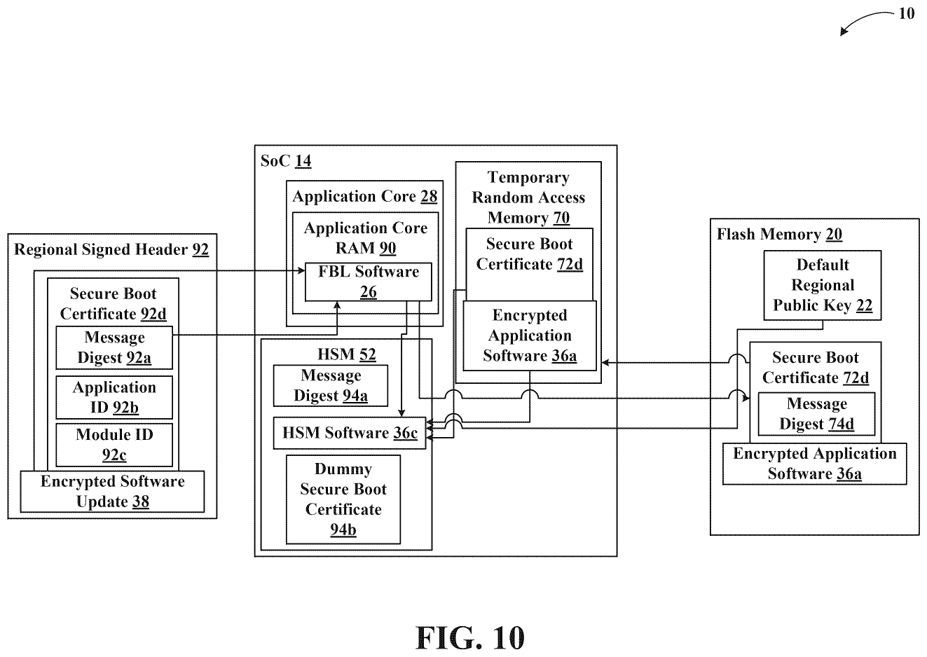

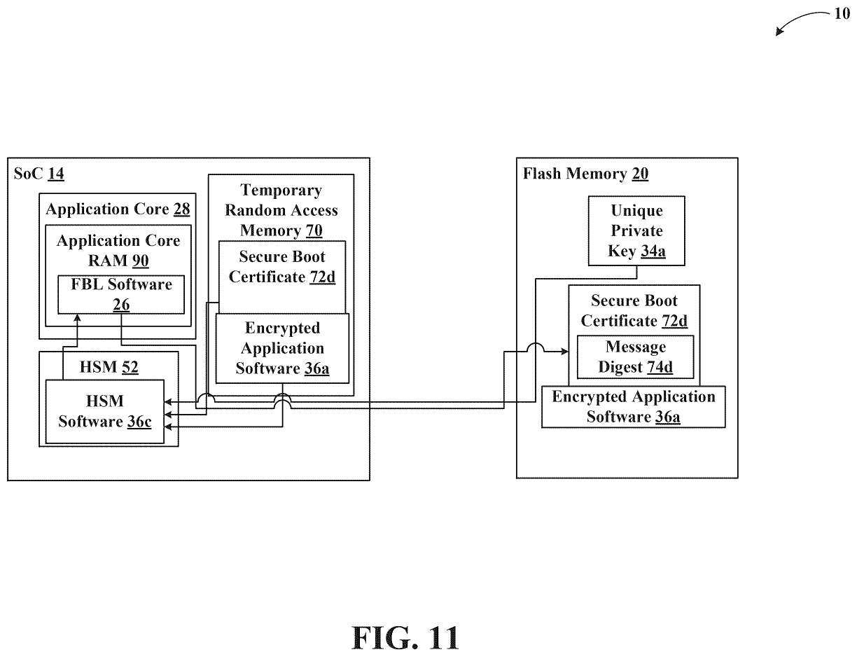

Referring now to FIGS. 10 and 11, the FBL SOFTWARE 26 may, in some instances, erase the application software 36a. For example, a programmed status indicator (PSI) may be revoked, and the application software 36a in the external flash memory 20 is erased. A regional signed header 92 is included with a software update 38, which is provided to the FBL SOFTWARE 26. The FBL SOFTWARE 26 asks the HSM 52 to verify the regional signed header 92. The HSM 52 is configured to verify the regional signed header 92 with the regional public key 22. The HSM 52 saves the corresponding message digest 92a, application identification (ID) 92b, module ID 92c, and secure boot certificate 92d from the regional signed header 92. Thus, the FBL SOFTWARE 26 of the SoC 14 receives a software update 38 and verifies the software update 38 using the verified regional public key 22 from the external flash memory 20. The FBL SOFTWARE 26 may then program an update in the external flash memory 20 and loads the software update 38 from the external flash memory 20 to the temporary random access memory 70. The FBL SOFTWARE 26 then asks the HSM 52 to generate a message digest 94a over the software update 38 that includes the application software 36c, a dummy secure boot certificate 94b, in the temporary random access memory 70 to verify that the software update 38 matches the saved message digest 74d from the verified regional signed header 92.

The HSM software 36c configures the MPU 64 to prevent writing to the temporary random access memory 70 until the HSM software 36c completes calculations associated with the update of the message digest 74. The HSM 52 is configured to generate a message digest 74 of the update and verifies the message digest 74 with the saved message digest 74d from the regional signed header 92. The HSM 52 reads the secure boot certificate 72d associated with the application software 36a and puts in the unique public key 34b and signs the certificate with the unique private key 34a. The HSM 52 returns the signed secure boot certificate 72d for the application software 36a if the message digest 74d passes verification. The FBL SOFTWARE 26 programs the secure boot certificate 72d in the external flash memory 20 and reads back the secure boot certificate 72d to confirm the successful write. The verification and signing of the secure boot certificate 72 allow the SoC 14 to perform secure boot at each startup since it will use the signed certificate with the message digest 74 within it to verify the external flash contents were unmodified.

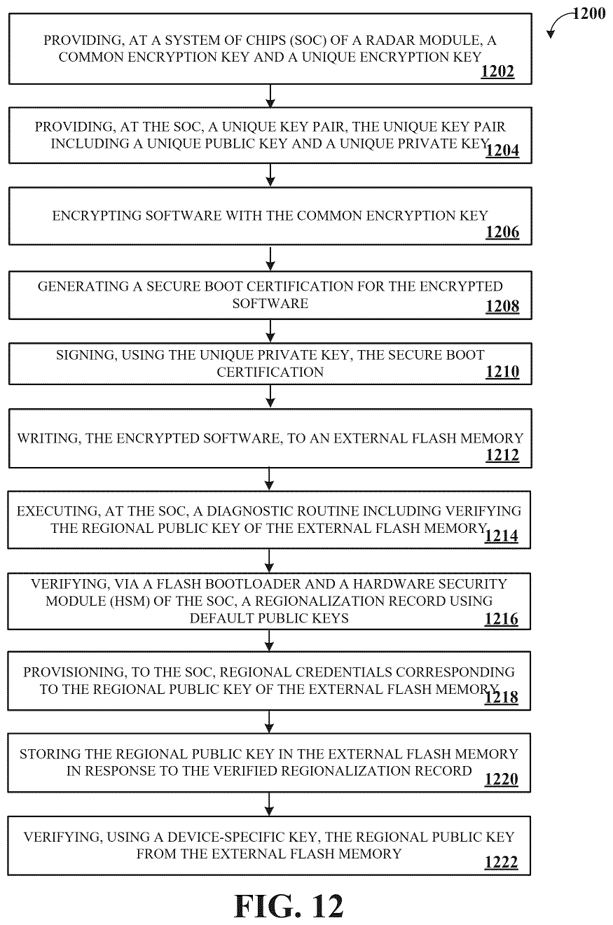

With reference to FIG. 12, an exemplary method 1200 for executing the regionalization system 10 is illustrated. At 1202, an SoC 14 of a radar module 100 is provided a common encryption key 30 and a unique encryption key 32. The SoC 14 is provided, at 1204, a unique key pair 34. The unique key pair 34 includes a unique public key 34b and a unique private key 34a. At 1206, software 36 is encrypted with the common encryption key 30, and at 1208, a secure boot certificate 72 for the encrypted software 36 is generated. At 1210, the secure boot certificate 72 is signed using the unique private key. The encrypted software 36, at 1212, is written to an external flash memory 20. The SoC 14 executes, at 1214, a diagnostic routine 48 including verifying the regional public key 22 of the external flash memory 20. An FBL SOFTWARE 26 and HSM 52 verify, at 1216, a regionalization record 54 using default regional public keys 56. The SoC 14 is provisioned, at 1218, the regional credentials 24 corresponding to the regional public key 22 of the external flash memory 20 and stores, 1220, the default regional public key 22 at the external flash memory 20 in response to the verified regionalization record 54. At 1222, verifying, using a device-specific key 34, the regional public key 22 from the external flash memory 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A computer-implemented method when executed by data processing hardware causes the data processing hardware to perform operations comprising:
providing, at a system on chips (SoC) of a radar module, a common encryption key and a unique encryption key;
providing, at the SoC, a unique key pair, the unique key pair including a unique public key and a unique private key;
encrypting software with the common encryption key;
generating a secure boot certificate for the encrypted software;
signing, using the unique private key, the secure boot certificate;
writing, the encrypted software, to an external flash memory;
updating, at the SoC, software;
verifying, via a regional public key, the software update; and
signing, via a hardware security module (HSM) of the SoC, the secure boot certificate with a device-unique private key.

2. The method of claim 1, wherein providing the unique key pair includes hashing the unique public key at a fuse of the SoC, storing hash of the unique public key in the fuses, and encrypting the unique private key with the unique encryption key.

3. The method of claim 1, wherein the external flash memory includes flash bootloader software including a default regional public key.

4. The method of claim 3, further including verifying, via a diagnostic routine with default regional public keys, the regional public key and regional credentials of the flash bootloader software.

5. The method of claim 4, further including verifying, via a flash bootloader of the SoC and the HSM of the SoC, a regionalization record using the default regional public keys.

6. The method of claim 5, further including:
storing the default regional public key and regional credentials in the external flash memory in response to the verified regionalization record;
executing, at the SoC, a diagnostic routine including verifying the regional public key of the external flash memory; and
provisioning, to the SoC, the regional credentials corresponding to the default regional public key of the external flash memory.

7. The method of claim 5, further including receiving, at a flash bootloader of the SoC, a software update and verifying, via the HSM, the software update using the regional public key from the external flash memory.

8. A regionalization system for a radar module of a vehicle, the regionalization system comprising:
data processing hardware; and
memory hardware in communication with the data processing hardware, the memory hardware storing instructions that when executed on the data processing hardware cause the data processing hardware to perform operations comprising:
providing, at a system on chips (SoC) of a radar module, a common encryption key and a unique encryption key;
providing, at the SoC, a unique key pair, the unique key pair including a unique public key and a unique private key;
encrypting software with the common encryption key;
generating a secure boot certificate for the encrypted software;
signing, using the unique private key, the secure boot certificate;
writing, the encrypted software, to an external flash memory;
executing, at the SoC, a diagnostic routine including verifying a regional root public key of the external flash memory; and
provisioning, to the SoC, regional credentials and the regional root public key.

9. The regionalization system of claim 8, wherein providing the unique key pair includes hashing the unique public key at fuses of the SoC, storing hash of the unique public key in the fuses, and encrypting the unique private key with the unique encryption key prior to storing the unique private key in the external flash memory.

10. The regionalization system of claim 8, wherein the external flash memory includes flash bootloader software including default regional public keys.

11. The regionalization system of claim 10, further including verifying, via the diagnostic routine with default regional public keys, the regional public key and the regional credentials and default credentials of the flash bootloader software.

12. The regionalization system of claim 11, further including verifying, via a flash bootloader of the SoC and a hardware security module (HSM) of the SoC, a regionalization record using the default regional public keys.

13. The regionalization system of claim 12, further including:
storing the regional public key and the regional credentials in the external flash memory in response to the verified regionalization record;
executing, at the SoC, a diagnostic routine including verifying the regional public key of the external flash memory; and
provisioning, to the SoC, regional credentials corresponding to the regional public key of the external flash memory.

14. The regionalization system of claim 12, further including receiving, at a flash bootloader of the SoC, a software update and verifying, via the HSM, the software update using the regional public key from the external flash memory.

15. A regionalization system for a vehicle, the regionalization system comprising:
data processing hardware; and
memory hardware in communication with the data processing hardware, the memory hardware storing instructions that when executed on the data processing hardware cause the data processing hardware to perform operations comprising:
providing, at a system on chips (SoC) of a radar module, a common encryption key and a unique encryption key;
providing, at the SoC, a unique key pair, the unique key pair including a unique public key and a unique private key;
encrypting software with the common encryption key;
generating a secure boot certificate for the encrypted software;
signing, using the unique private key, the secure boot certificate;
writing, the encrypted software, to an external flash memory;
executing, at the SoC, a diagnostic routine including verifying a default regional public key of the external flash memory;
verifying, via a flash bootloader of the SoC and a hardware security module (HSM) of the SoC, a regionalization record using the default regional public key of the external flash memory and regional credentials;
provisioning, to the SoC, regional credentials and the default regional public key; and
storing the provisioned regional credentials in response to the verified regionalization record.

16. The regionalization system of claim 15, wherein providing the unique key pair includes hashing the unique public key at fuses of the SoC, storing hash of the unique public key in the fuses, and encrypting the unique private key with the unique encryption key.

17. The regionalization system of claim 15, wherein the external flash memory includes flash bootloader software including the default regional public key.

18. The regionalization system of claim 17, further including verifying, via the diagnostic routine with the regional public key, the regional public key and the regional credentials of the flash bootloader software.

19. The regionalization system of claim 15, further including storing the provisioned regional credentials in response to the verified regionalization record.

20. The regionalization system of claim 15, further including receiving, at a flash bootloader of the SoC, a software update and verifying, via the HSM, the software update using the default regional public key from the external flash memory.
